(19) United States
(12) Patent Application Publication
(10) Pub. No.: US 2010/0171784 A1
(43) Pub. Date: Jul. 8, 2010

(54) IMAGE RECORDING APPARATUS

(75) Inventors: Takaya Kitawaki, Shizuoka-ken (JP); Satoshi Kaiho, Kanagawa-ken (JP); Atsushi Kubota, Shizuoka-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/652,326

(22) Filed: Jan. 5, 2010

Related U.S. Application Data
(60) Provisional application No. 61/142,733, filed on Jan. 6, 2009.

(51) Int. Cl. B41J 29/38

(52) U.S. Cl. 347/16; 347/104

(57) ABSTRACT

An image recording apparatus includes a recording head and a first conveyance unit. An applying unit applies the recording medium on the first conveyance unit with treatment liquid. One end of a second conveyance unit is connected on an upstream side from the applying unit disposed on the first conveyance unit and the other end is connected on a downstream side from the applying unit disposed on the first conveyance unit and on the upstream side from the recording head in the conveyance direction, the second conveyance unit conveying the recording medium. A conveyance switching unit is disposed on the one end of the second conveyance unit and switches conveyance of the recording medium to the applying unit side of the first conveyance unit or to the second conveyance unit side according to a content of recording data.

### CROSS-REFERENCE TO RELATED APPLICATION

This application is based upon and claims the benefit of priority from: U.S. Provisional Application No. 61/142,733 filed on Jan. 06, 2009, the entire contents of each of which are incorporated herein by reference.

### TECHNICAL FIELD

The present invention relates to an image recording apparatus for applying a recording medium with a preprocessing solution which serves to shorten time for fixing ink on the recording medium.

### BACKGROUND

As for image recording apparatuses, there is an ink jet recording apparatus which is provided with ink jet heads. While conveying recording mediums such as paper by a conveyance unit, the ink jet recording apparatus ejects ink from the ink jet heads so as to carry out recording on the recording mediums. In order to rapidly fix ink on the recording mediums, the ink jet recording apparatus applies a preprocessing solution on the recording mediums before the ink is ejected from the ink jet heads. For example, a technique of applying the preprocessing solution on the recording medium is disclosed in JP-A-2008-279773. In the technique, there is provided an applying process path to apply the recording medium with the preprocessing solution and a non-applying process path not to apply the recording medium with the preprocessing solution. Further, when the recording medium which does not require such applying, for example, a recording paper for overhead projector (OHP) or a glossy film, it is guided to the non-applying process path so as to carry out recording without applying the preprocessing solution.

In the above technique, when it is determined that the recording medium requires applying with the preprocessing solution, regardless of the contents of the recording data to be recorded on the recording medium, the recording medium is applied with the preprocessing solution. According to the contents of the recording data to be recorded on the recording medium, there may not need the preprocessing solution to be applied. For this reason, even the recording medium which does not require the preprocessing solution to be applied is applied with the preprocessing solution, so that the amount of preprocessing solution consumed is increased.

### SUMMARY

An image recording apparatus according to a first aspect of the present invention comprises a recording head which ejects an ink on a recording medium to be recorded; an applying unit which is disposed on an upstream side from the recording head and applies the recording medium with treatment liquid; a first conveyance unit which conveys the recording medium to the recording head, disposes with the applying unit; a second conveyance unit of which one end is connected on an upstream side from the applying unit disposed on the first conveyance unit in a conveyance direction of the recording medium and the other end is connected on a downstream side from the applying unit disposed on the first conveyance unit in the conveyance direction of the recording medium and on the upstream side from the recording head in the conveyance direction, the second conveyance unit conveying the recording medium; and a conveyance switching unit which is disposed on the one end of the second conveyance unit and switches conveyance of the recording medium to the applying unit side of the first conveyance unit or to the second conveyance unit side according to a content of recording data which is to be recorded on the recording medium.

An image recording method according to a second aspect of the present invention comprises: guiding a recording medium, according to the content of recording data to be recorded on the recording medium, to a first conveyance unit which includes an applying unit which applies the recording medium with treatment liquid, or a second conveyance unit of which one end is connected to the first conveyance unit on an upstream side from the applying unit in a conveyance direction and the other end is connected to the first conveyance unit on a downstream side from the applying unit in the conveyance direction and on an upstream side from a recording head in the conveyance direction; and ejecting ink from the recording head according to the recording data to perform recording on the recording medium.

### DESCRIPTION OF THE DRAWINGS

FIG. 1 is a diagram illustrating a configuration of an image recording apparatus according to an embodiment of the invention.

FIG. 2 is a diagram illustrating a conveyance switching unit according to the image recording apparatus.

FIG. 3 is a diagram illustrating a recording control unit according to the image recording apparatus.

FIG. 4 is a flowchart illustrating the first conveyance switching according to the image recording apparatus.

FIG. 5 is a flowchart illustrating the second conveyance switching according to the image recording apparatus.

FIG. 6 is a flowchart illustrating the third conveyance switching according to the image recording apparatus.

FIG. 7 is a flowchart illustrating a recording operation with no residue according to the image recording apparatus.

### DETAILED DESCRIPTION

Hereinafter, an embodiment of the invention will be described with reference to the drawings.

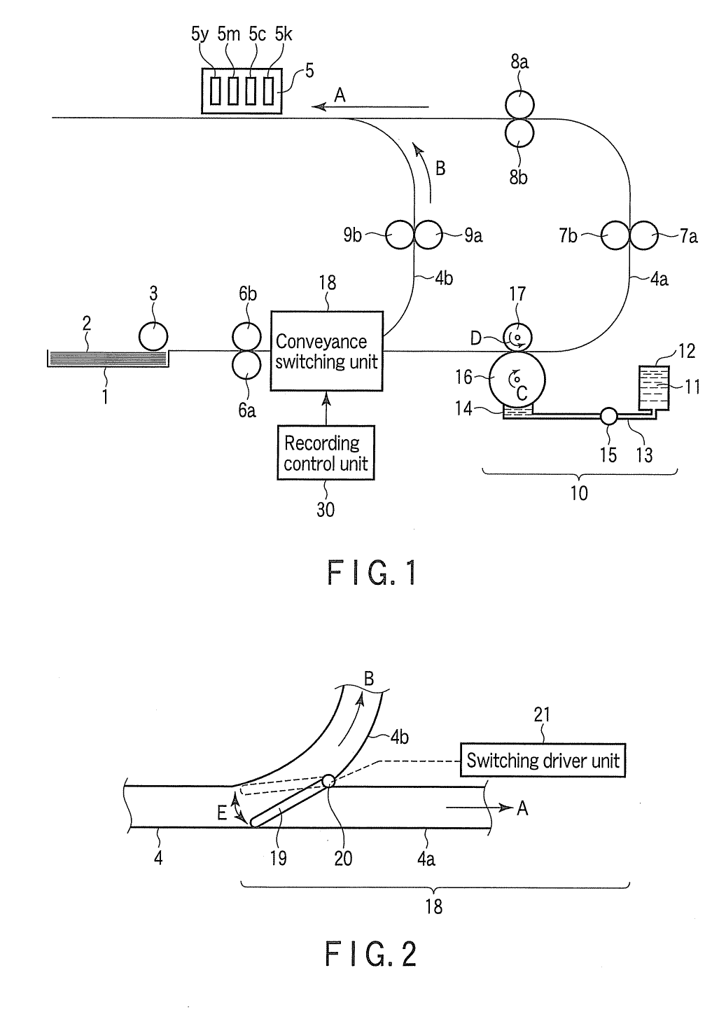

FIG. 1 is a diagram illustrating the configuration of the image recording apparatus. The image recording apparatus 100 is provided with a paper feeding unit 1.

The paper feeding unit 1 contains a plurality of stacked recording mediums 2. As for the recording medium 2, there may be exemplified various kinds of paper, such as special paper used for ink jet recording or plain paper. A paper feeding roller 3 is provided at the paper feeding side of the paper feeding unit 1. The paper feeding roller 3 picks up the recording medium 2 on the top position, among the plurality of the recording mediums 2 contained in the paper feeding unit 1, one by one so as to be fed to a first conveyance path 4a.

The first conveyance path 4a guides the recording medium 2 fed from the paper feeding unit 1 in a conveyance direction A. In the first conveyance path 4a, for example, three pairs of conveyance rollers 6a, 6b, 7a, 7b, 8a, and 8b are provided. The respective pairs of the conveyance rollers 6a, 6b, 7a, 7b, 8a, and 8b rotate to convey the recording medium 2 onto the first conveyance path 4a.

In the first conveyance path 4a, an ink jet head 5 is provided as a recording head. The ink jet head 5 ejects ink onto the recording medium 2 which is being conveyed on the first conveyance path 4a, so that an image is recorded on the recording medium 2. For example, the ink jet head 5 includes four ink jet heads 5k, 5c, 5m, and 5y. The respective ink jet heads 5k, 5c, 5m, and 5y are disposed at a predetermined interval in the conveyance direction A of the first conveyance path 4a. The respective ink jet heads 5k, 5c, 5m, and 5y eject colors of ink, for example, black (K), cyan (C), magenta (M), and yellow (Y). The number of the ink jet heads 5k, 5c, 5m, and 5y is not limited to 4, but at least one of the ink jet heads may be disposed.

An applying unit 10 provides on the first conveyance path 4a. The applying unit 10 is disposed on the upstream side from the ink jet head 5 in the conveyance direction A of the recording medium 2, and applies treatment liquid 11 to the recording medium 2 conveyed on the first conveyance path 4a. For example, the treatment liquid 11 includes a polymer solution, such as carboxymethyl cellulose, polyvinyl alcohol or polyvinyl acetate.

Specifically, the applying unit 10 is provided with a processing solution tank 12. In the processing solution tank 12, the treatment liquid 11 is stored. At the bottom of the processing solution tank 12, a treatment liquid supply end 14 is connected via a processing solution supply path 13. A processing solution supply pump 15 is provided at the processing solution supply path 13. The processing solution supply pump 15 is driven to supply the treatment liquid 11 stored in the processing solution tank 12 to the treatment liquid supply end 14 through the processing solution supply path 13.

The surface of an applying roller 16 comes into contact with the treatment liquid supply end 14. The treatment liquid supply end 14 supplies the treatment liquid the surface of the applying roller 16. An auxiliary roller 17 faces the applying roller 16 via the first conveyance path 4a. The applying roller 16 and the auxiliary roller 17 contact each other and rotate in arrow directions C and D, respectively. The applying roller 16 rotates in the arrow direction C while being subjected to the application of the treatment liquid 11 from the treatment liquid supply end 14, and applies the treatment liquid 11 to the recording medium 2 conveyed on the first conveyance path 4a.

A second conveyance path 4b provides in parallel with the first conveyance path 4a. One end of the second conveyance path 4b is connected on the upstream side from the applying unit 10 disposed on the first conveyance path 4a in the conveyance direction A of the recording medium 2. The other end of the second conveyance path 4b is connected on the downstream side from the applying unit 10 disposed on the first conveyance path 4a in the conveyance direction A and the upstream side from the ink jet head 5 in the conveyance direction A. Specifically, one end of the second conveyance path 4b is connected between a pair of the conveyance rollers 6a and 6b and the applying unit 10 in the first conveyance path 4a. The other end of the second conveyance path 4b is connected between a pair of the conveyance rollers 8a and 8b and the ink jet head 5 in the first conveyance path 4a.

For example, a pair of conveyance rollers 9a and 9b is provided on the second conveyance path 4b. The pair of the conveyance rollers 9a and 9b rotate to convey the recording medium 2 in the conveying direction B toward the ink jet head 5 disposed on the first conveyance path 4a.

A conveyance switching unit 18 is disposed on one end of the second conveyance path 4b. The conveyance switching unit 18 switches the conveyance of the recording medium 2 between the applying unit 10 of the first conveyance path 4a and the second conveyance path 4b according to the contents of recording data to be recorded on the recording medium 2.

FIG. 2 is a diagram illustrating the configuration of the conveyance switching unit 18. The conveyance switching unit 18 is provided with a switching plate 19 as a switching member. The switching plate 19 is provided with a rotating unit 20 on one side thereof.

The rotating unit 20 is connected to a switching driver unit 21. The switching driver unit 21 includes a motor and the like, and rotates the switching plate 19 around the rotating unit 20 in an arrow direction E. The switching plate 19 rotates around the rotating unit 20 so as to open the first conveyance path 4a and close the second conveyance path 4b, or to close the first conveyance path 4a and open the second conveyance path 4b.

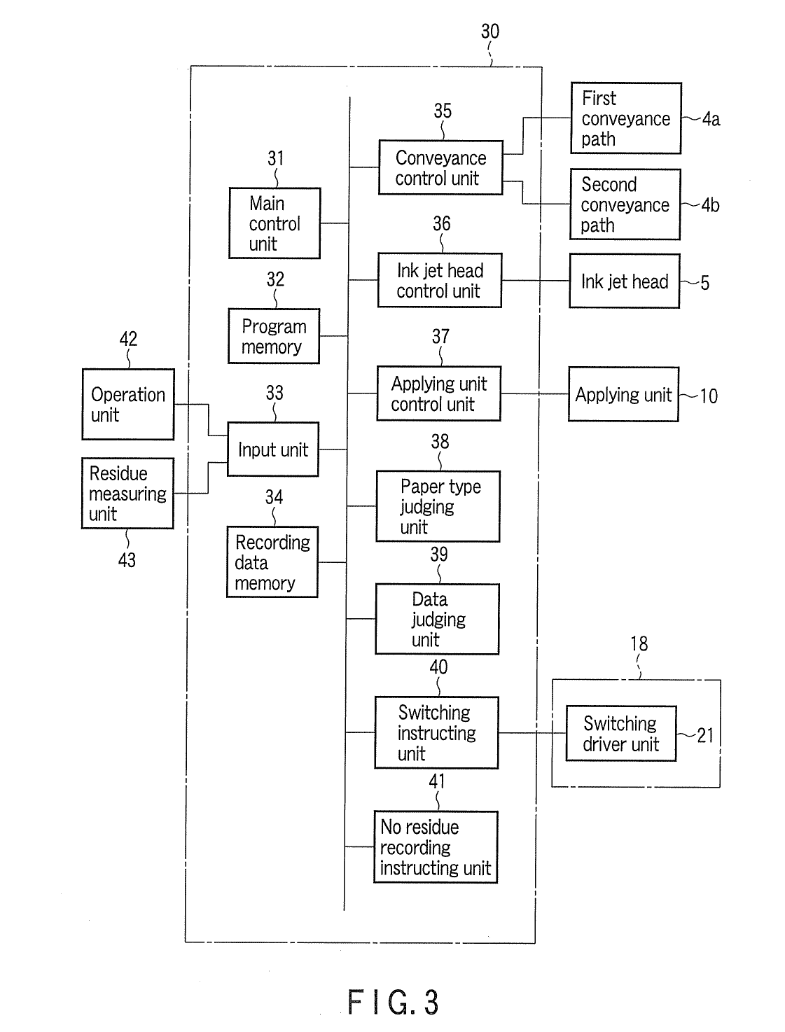

FIG. 3 is a diagram illustrating the configuration of a recording control unit 30. The recording control unit 30 includes a main control unit 31 constituted by a CPU and the like. The main control unit 31 is connected to a program memory 32, an input unit 33, a recording data memory 34, a conveyance control unit 35, an ink jet head control unit 36, an applying unit control unit 37, a paper type judging unit 38, a data judging unit 39, a switching instructing unit 40, and a no residue recording instructing unit 41. The input unit 33 is connected to an operation unit 42 and a residue measuring unit 43. The conveyance control unit 35 is connected to each of the motors 35a and 35b for driving the respective conveyance rollers 6a, 7a, 8a, 9a which are disposed on the first conveyance path 4a and the second conveyance path 4b. The ink jet head control unit 36 is connected to the ink jet head 5. The applying unit control unit 37 is connected to the processing solution supply pump 15 and each of the motors 37a and 37b for driving the applying roller 16.

The program memory 32 stores an image recording program in advance. The image recording program stores functions for guiding the recording medium 2 to the first conveyance path 4a having the applying unit 10 or to the second conveyance path 4b according to the contents of the recording data to be recorded on the recording medium 2, and for recording on the recording medium 2 by ejecting ink from the ink jet head 5 according to the recording data.

The main control unit 31 executes the image recording program which is stored in the program memory 32 and issues operation instructions to the conveyance control unit 35, the ink jet head control unit 36, the applying unit control unit 37, the paper type judging unit 38, the data judging unit 39, and the switching instructing unit 40.

The recording data memory 34 stores the recording data to be recorded on the recording medium 2. As the recording data, data read by an image scanner or data which is transmitted through a network and stored in the recording data memory 25 are exemplified. The contents of the recording data include any one of color information or monochrome information. The contents of the recording data include any one of graph data or text data. The contents of the recording data include data indicating whether a print ratio to the recording medium 2 is higher than a predetermined print ratio or not.

The operation unit 42 is constituted by various operation keys, a keyboard, and the like. When a user manually operates the operation unit 42, the operation unit 42 receives an instruction. For example, it is possible to instruct the starting of recording or the setting of whether or not the recording medium 2 is to be applied with the treatment liquid 11. The operation unit 42 can set the type of the recording medium 2, for example, plain paper or special paper for image recording.

The residue measuring unit 43 calculates a residue quantity of the treatment liquid 11 in the processing solution tank 12, and outputs a residue measurement signal.

The conveyance control unit 35 rotates the respective pairs of the conveyance rollers 6a, 6b, 7a, 7b, 8a, and 8b and the like disposed on the first conveyance path 4a so as to convey the recording medium 2 onto the first conveyance path 4a. The conveyance control unit 35 rotates the pair of conveyance rollers 6a and 6b disposed on the second conveyance path 4b so as to convey the recording medium 2 onto the second conveyance path 4b.

The ink jet head control unit 36 controls the ejecting of ink from the ink jet head 5 according to the recording data.

The applying unit control unit 37 controls the processing solution supply pump 15 in the applying unit 10 to be driven, and controls the applying roller 16 to be rotated.

The paper type judging unit 38 judges whether the type of the recording medium 2 set by the operation unit 42 is the plain paper or the special paper for image recording.

The data judging unit 39 judges whether the contents of the recording data are color information or other data, for example, monochrome information. The data judging unit 39 judges whether the contents of the recording data are graph data or other data, for example, text data. The data judging unit 39 judges whether the print ratio of the contents of the recording data on the recording medium 2 is higher than a predetermined print ratio or not.

The data judging unit 39 performs the determination of the contents of the recording data on each recording medium 2. The data judging unit 39 performs the determination of the contents of the recording data for each job.

When the data judging unit 39 judges that the contents of the recording data are the color information, the switching instructing unit 40 issues an instruction to the switching driver unit 21 so as to be in the open state toward the applying unit 10 disposed on the first conveyance path 4a. When it is determined that the contents of the recording data are the monochrome information, the switching instructing unit 40 issues an instruction to the switching driver unit 21 so as to be in the open state toward the second conveyance path 4b.

When the data judging unit 39 judges that the contents of the recording data are the graph data, the switching instructing unit 40 issues an instruction to the switching driver unit 21 so as to be in the open state toward the applying unit 10 disposed on the first conveyance path 4a. When it is determined that the contents of the recording data are the text data, the switching instructing unit 40 issues an instruction to the switching driver unit 21 so as to be in the open state toward the second conveyance path 4b.

When the data judging unit 39 judges that the print ratio of the contents of the recording data on the recording medium 2 is higher than a predetermined print ratio, the switching instructing unit 40 issues an instruction to the switching driver unit 21 so as to be in the open state toward the applying unit 10 of the first conveyance path 4a. When it is determined that the print ratio to the recording medium 2 is lower than a predetermined print ratio, the switching instructing unit 40 issues an instruction to the switching driver unit 21 so as to be in the open state toward the second conveyance path 4b.

The no residue recording instructing unit 41 receives the residue measurement signal from the residue measuring unit 43, and judges whether or not there is no residue of the treatment liquid 11 in the processing solution tank 12. As a result of the determination, when it is determined that there is no residue of the treatment liquid 11, the no residue recording instructing unit 41 issues an instruction to the switching instructing unit 40 to carry out recording of the recording data on the recording medium 2 without applying the treatment liquid 11. When receiving the recording instruction without applying, the switching instructing unit 40 issues an instruction to the switching driver unit 21 so as to be in the open state toward the second conveyance path 4b.

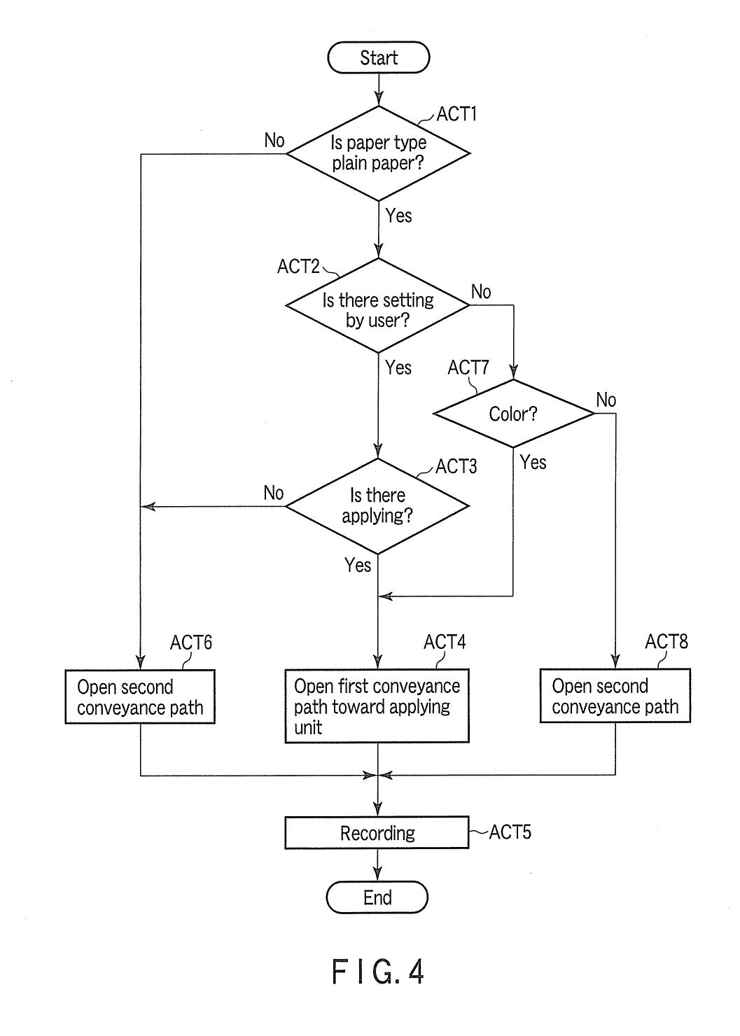

Next, the recording operation when the contents of the recording data are the color information or the monochrome information in the apparatus as configured above will be described with reference to the flowchart of the first conveyance switching shown in FIG. 4.

The paper type judging unit 38 judges whether the type of the recording medium 2 set by the operation unit 42 is the plain paper or the special paper for the image recording (Act 1).

When the type of the recording medium 2 is determined as the plain paper (YES in Act 1), the main control unit 31 determines whether the applying of the treatment liquid 11 is set by a user using the operation unit 42 (Act 2).

When it is determined that the applying of the treatment liquid 11 is set (YES in Act 2), the main control unit 31 determines whether the setting of the applying of the treatment liquid 11 corresponds to applying or no applying (Act 3).

When it is determined that the setting corresponds to applying of the treatment liquid 11 (YES in Act 3), the main control unit 31 issues an instruction to the switching instructing unit 40 to carry out the recording of the recording data on the recording medium 2 with the application of the treatment liquid 11. The switching instructing unit 40 receives the instruction from the main control unit 31 and issues an instruction to the switching driver unit 21 so as to be in the open state toward the applying unit 10 disposed on the first conveyance path 4a. The conveyance switching unit 18 rotates the switching plate 19 around the rotating unit 20 so as to be in the open state toward the applying unit 10 disposed on the first conveyance path 4a (Act 4), and closes the second conveyance path 4b.

Further, the main control unit 31 issues operation instructions to the conveyance control unit 35, the ink jet head control unit 36, and the applying unit control unit 37. The conveyance control unit 35 rotates the respective pairs of the conveyance rollers 6a, 6b, 7a, 7b, 8a, and 8b and the like disposed on the first conveyance path 4a so as to convey the recording medium 2 disposed on the first conveyance path 4a. The ink jet head control unit 36 controls the ejecting of ink from the ink jet head 5 according to the recording data which is stored in the recording data memory 34. The applying unit control unit 37 controls the processing solution supply pump 15 in the applying unit 10 to be driven, and controls the applying roller 16 and the auxiliary roller 17 to be rotated.

As a result, the paper feeding roller 3 picks up the recording medium 2 on the top position, among the plurality Of the recording mediums 2 contained in the paper feeding unit 1, one by one so as to be fed to a first conveyance path 4a. The recording medium 2 is conveyed along the first conveyance path 4a so as to reach the conveyance switching unit 18. Since the conveyance switching unit 18 is opened toward the applying unit 10 disposed on the first conveyance path 4a, the recording medium 2 is conveyed toward the applying unit 10 disposed on the first conveyance path 4a.

The processing solution supply pump 15 is driven to supply the treatment liquid 11 in the processing solution tank 12 to the treatment liquid supply end 14 through the processing solution supply path 13. The applying roller 16 and the auxiliary roller 17 come into contact with each other and rotate in the arrow directions A and B, respectively. The applying roller 16 rotates in the arrow direction A while being supplied with the treatment liquid 11 from the treatment liquid supply end 14. Further, the applying roller 16 applies the treatment liquid 11 on the recording medium 2 which is conveyed on the first conveyance path 4a.

The recording medium 2 applied with the treatment liquid 11 is conveyed on the first conveyance path 4a and conveyed under the ink jet head 5. The ink jet head 5 ejects ink onto the recording medium 2 conveyed on the first conveyance path 4a to record an image on the recording medium 2 (Act 5).

On the other hand, when it is determined that the setting corresponds to no applying of the treatment liquid 11 (NO in Act 3), the main control unit 31 issues an instruction to the switching instructing unit 40 to carry out the recording of the recording data on the recording medium 2 with no applying of the treatment liquid 11. The switching instructing unit 40 receives the instruction from the main control unit 31 and issues an instruction to the switching driver unit 21 so as to be in the open state toward the second conveyance path 4b. The conveyance switching unit 18 rotates the switching plate 19 around the rotating unit 20 so as to be in the open state toward the second conveyance path 4b (Act 6), and to be in the closed state toward the applying unit 10 disposed on the first conveyance path 4a.

As a result, the recording medium 2 is conveyed to the second conveyance path 4b from the first conveyance path 4a, enters through the first conveyance path 4a once again, and is conveyed under the ink jet head 5.

The ink jet head 5 ejects ink onto the recording medium 2 conveyed on the first conveyance path 4a to record an image on the recording medium 2.

As a result of the determination whether the applying of the treatment liquid 11 is set by a user (Act 2), when it is determined that there is no setting of the applying of the treatment liquid 11 (NO in Act 2), the data judging unit 39 judges whether the contents of the recording data are the color information (Act 7). Specifically, the data judging unit 39 judges whether the contents of the recording data are the color information or the monochrome information.

When it is determined that the contents of the recording data are the color information (YES in Act 7), the main control unit 31 issues an instruction to the switching instruction unit 40 to carry out the recording of the recording data on the recording medium 2 with the application of the treatment liquid 11. As a result, since the conveyance switching unit 18 is in the open state toward the applying unit 10 disposed on the first conveyance path 4a (Act 4), the treatment liquid 11 is applied on the recording medium 2 as described above. Thereafter, an image is recorded on the recording medium 2 (Act 5).

When it is determined that the contents of the recording data are the monochrome information (NO in Act 2), the main control unit 31 issues an instruction to the switching instruction unit 40 to carry out the recording of the recording data on the recording medium 2 with no applying of the treatment liquid 11. As a result, since the conveyance switching unit 18 is in the open state toward the second conveyance path 4b (Act 8), the treatment liquid 11 is not applied on the recording medium 2 as described above. Thereafter, an image is recorded on the recording medium 2 (Act 5).

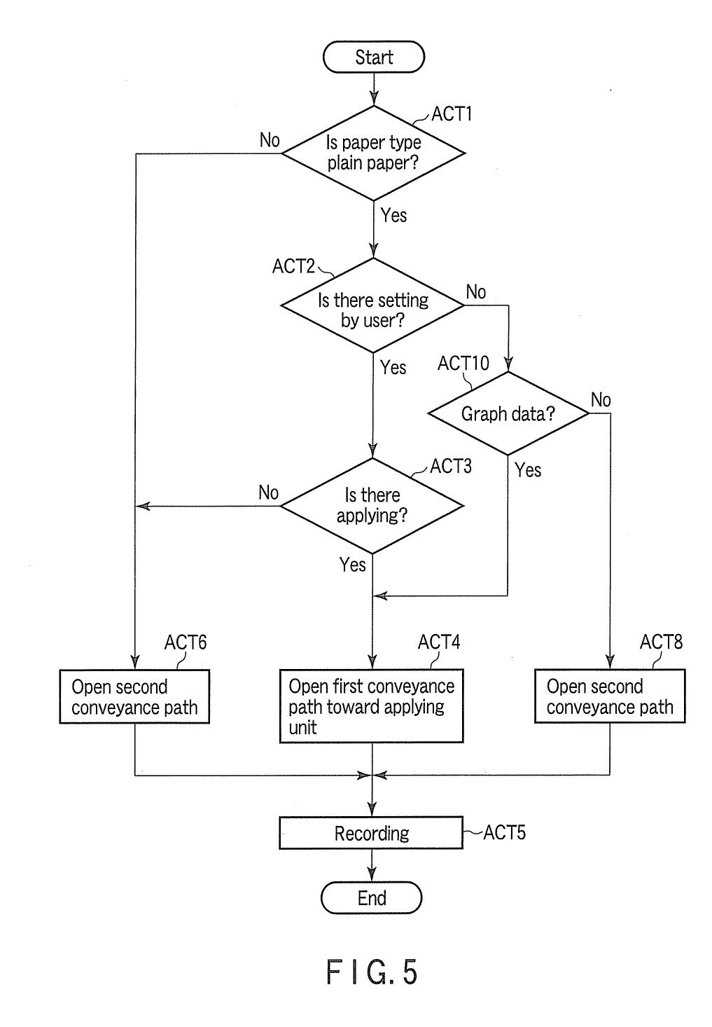

Next, the recording operation when the contents of the recording data are the graph data or the text data will be described with reference to the flowchart of the second conveyance switching shown in FIG. 5. Further, the description of the same Acts as those in FIG. 4 will be omitted.

When it is determined that there is no setting by a user (NO in Act 2), the data judging unit 39 judges whether or not the contents of the recording data are the graph data (Act 10). Specifically, the data judging unit 39 judges whether the contents of the recording data are the. graph data or the test data. When it is determined that the contents of the recording data are the graph data (YES in Act 10), the conveyance switching unit 18 is in the open state toward the applying unit 10 disposed on the first conveyance path 4a (Act 4). The recording medium 2 is applied with the treatment liquid 11. Thereafter, an image is recorded on the recording medium 2 (Act 5).

When it is determined that the contents of the recording data are the text data (NO in Act 10), the conveyance switching unit 18 is in the open state toward the second conveyance path 4b (Act 8). The recording medium 2 is not applied with the treatment liquid 11, and an image is recorded on the recording medium 2 (Act 5).

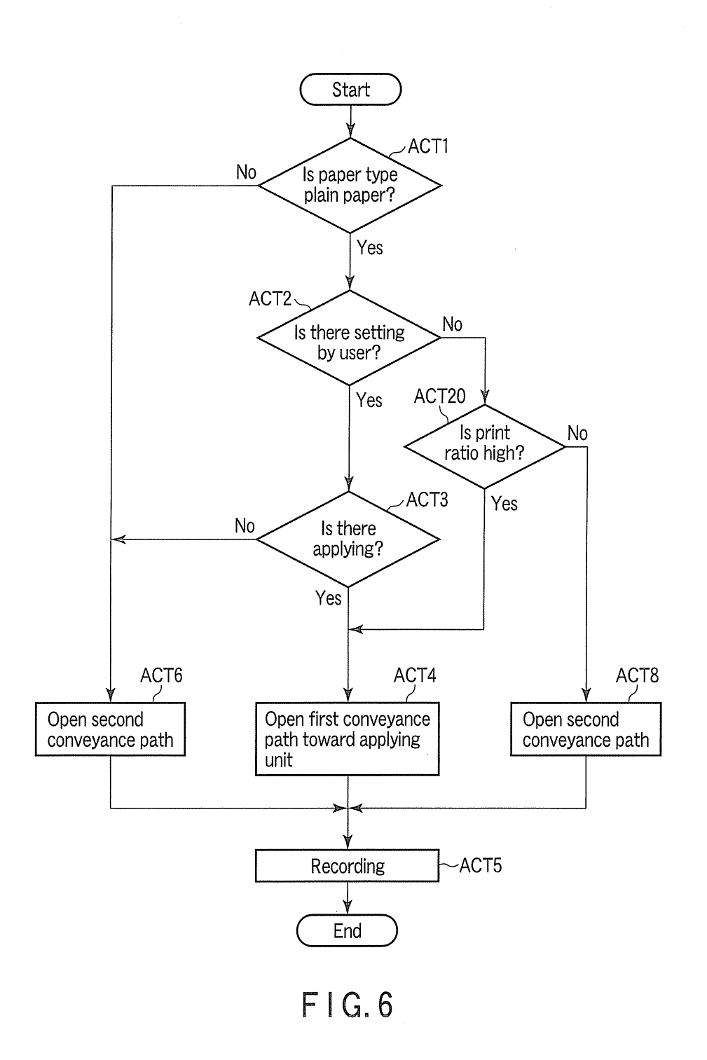

Next, the recording operation when the print ratio of the contents of the recording data on the recording medium 2 is higher than a predetermined print ratio or lower will be described with reference to the flowchart of the third conveyance switching shown in FIG. 6. Further, the description of the same Acts as those in FIG. 4 will be omitted.

When it is determined that there is no setting by a user (NO in Act 2), the data judging unit 39 judges whether or not the print ratio of the contents of the recording data on the recording medium 2 is higher than a predetermined print ratio (Act 20). Specifically, the data judging unit 39 judges whether the print ratio of the contents of the recording data on the recording medium 2 is higher than a predetermined print ratio or lower.

When it is determined that the print ratio on the recording medium 2 is higher than a predetermined print ratio (YES in Act 20), the conveyance switching unit 18 is in the open state toward the applying unit 10 disposed on the first conveyance path 4a (Act 4). The recording medium 2 is applied with the treatment liquid 11. Thereafter, an image is recorded on the recording medium (Act 5).

When it is determined that the print ratio on the recording medium 2 is lower than a predetermined print ratio (NO in Act 20), the conveyance switching unit 18 is in the open state toward the second conveyance path 4b (Act 8). The recording medium 2 is not applied with the treatment liquid 11. Thereafter, an image is recorded on the recording medium (Act 5).

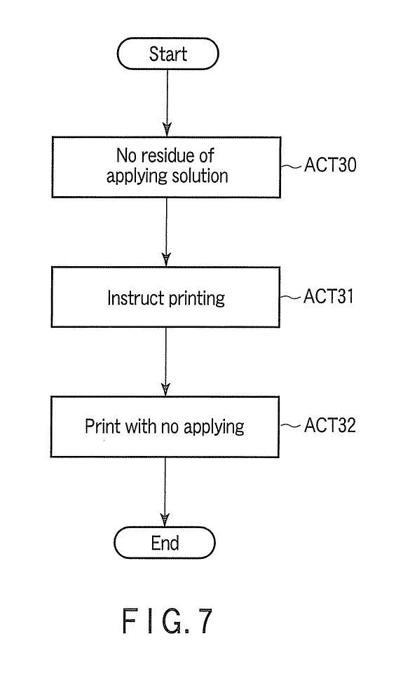

Next, the recording operation when there is no residue of the treatment liquid 11 will be described with reference to the flowchart of the no residue recording operation shown in FIG. 7.

The residue measuring unit 43 measures a residue of the treatment liquid 11 in the processing solution tank 12, and outputs the residue measurement signal.

The no residue recording instructing unit 41 receives the residue measurement signal from the residue measuring unit 43, and determines whether or not there is no residue of the treatment liquid 11 in the processing solution tack 12 (Act 30).

When there is no residue of the treatment liquid 11, the no residue recording instructing unit 41 issues an instruction to the switching instructing unit 40 to carry out the recording of the recording data on the recording medium 2 with no applying of the treatment liquid 11 (Act 31).

When receiving the recording instruction without applying, the switching instructing unit 40 issues an instruction to the switching driver unit 21 to be in the open state toward the second conveyance path 4b. The conveyance switching unit 18 rotates the switching plate 19 around the rotating unit 20 so as to be in the open state toward the second conveyance path 4b, and in the closed state toward the applying unit 10 disposed on the first conveyance path 4a. Therefore, as described above, the recording operation is carried out without applying the treatment liquid 11.

According to the embodiment as described above, it is determined whether the contents of the recording data are the color information or the graph data, and whether the print ratio on the recording medium 2 is higher than a predetermined print ratio. According to the determination result, the recording medium 2 is guided to any one of the first conveyance path 4a having the applying unit 10 or the second conveyance path 4b. Then, the recording operation is carried out with or without applying the treatment liquid 11. When the recording data needs to be applied with the treatment liquid 11, the recording medium 2 is applied with the treatment liquid 11. When the recording data does not need to be applied with the treatment liquid 11, the recording medium 2 is not applied with the treatment liquid 11. As a result, the amount of treatment liquid consumed can be suppressed to a minimum.

The determination of the contents of the recording data is carried out for each one of the recording mediums 2. Therefore, even when the recording data requiring the application of the treatment liquid 11 and the recording data not requiring the application are mixed, it is possible to carry out the recording operation on each one of the recording mediums 2 with or without applying the treatment liquid 11. Therefore, the amount of treatment liquid consumed can be suppressed to a minimum. Even when the determination of the contents of the recording data is carried out for each job, the amount of treatment liquid consumed can be suppressed to a minimum.

Even when the recording data requiring the application of the treatment liquid 11 and the recording data not requiring the application are mixed, the recording medium 2 is conveyed to the first conveyance path 4a or to the second conveyance path 4b. Therefore, the recording speed on the recording medium 2 is not reduced.

Even when there is no residue of the treatment liquid 11, the recording medium 2 is conveyed to the second conveyance path 4b. Therefore, the recording operation can be carried out without applying the treatment liquid 11.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image recording apparatus comprising:
a recording head which ejects an ink on a recording medium to be recorded;
an applying unit which is disposed on an upstream side from the recording head and applies the recording medium with treatment liquid;
a first conveyance unit which conveys the recording medium to the recording head, disposes with the applying unit;
a second conveyance unit of which one end is connected on an upstream side from the applying unit disposed on the first conveyance unit in a conveyance direction of the recording medium and the other end is connected on a downstream side from the applying unit disposed on the first conveyance unit in the conveyance direction of the recording medium and on the upstream side from the recording head in the conveyance direction, the second conveyance unit conveying the recording medium; and
a conveyance switching unit which is disposed on the one end of the second conveyance unit and switches conveyance of the recording medium to the applying unit side of the first conveyance unit or to the second conveyance unit side according to a content of recording data which is to be recorded on the recording medium.

2. The apparatus according to claim 1,
wherein the conveyance switching unit switches to be in an open state toward the applying unit disposed on the first conveyance unit if the content of the recording data is color information.

3. The apparatus according to claim 1,
wherein the conveyance switching unit switches to be in an open state toward the applying unit disposed on the first conveyance unit if the content of the recording data includes at least graph data.

4. The apparatus according to claim 1,
wherein the conveyance switching unit switches to be in an open state toward the applying unit disposed on the first conveyance unit if a print ratio on the recording medium by the recording data is higher than a predetermined print ratio.

5. The apparatus according to claim 1,
wherein the conveyance switching unit includes a switching member of which one end is rotatably provided so as to switch to be in an open state toward the applying unit disposed on the first conveyance unit or to be in an open state toward the second conveyance unit.

6. The apparatus according to claim 5, further comprising:
a recording data determining unit which determines a content of the recording data; and
a switching instructing unit which instructs the switching member to be switched according to the content of the recording data determined by the recording data determining unit.

7. The apparatus according to claim 6,
wherein the switching instructing unit issues an instruction to the switching member so as to be in an open state toward the applying unit disposed on the first conveyance unit if the recording data is color information.

8. The apparatus according to claim 6,
wherein the switching instructing unit issues an instruction to the switching member so as to be in an open state toward the applying unit disposed on the first conveyance unit if the recording data is graph data.

9. The apparatus according to claim 6,
wherein the switching instructing unit issues an instruction to the switching member so as to be in an open state toward the applying unit disposed on the first conveyance unit if the print ratio on the recording medium by the recording data is higher than a predetermined print ratio.

10. The apparatus according to claim 6,
wherein the switching instructing unit is activated if a type of the recording medium is a plain paper.

11. The apparatus according to claim 1,
wherein the conveyance switching unit determines the content of the recording data for each one of the recording mediums.

12. The apparatus according to claim 1,
wherein the conveyance switching unit determines the content of the recording data for each job.

13. An image recording method comprising:
guiding a recording medium, according to a content of recording data to be recorded on the recording medium, to a first conveyance unit which includes an applying unit which applies the recording medium with treatment liquid, or a second conveyance unit of which one end is connected to the first conveyance unit on an upstream side from the applying unit in a conveyance direction and the other end is connected to the first conveyance unit on a downstream side from the applying unit in the conveyance direction and on an upstream side from a recording head in the conveyance direction; and
ejecting ink from the recording head according to the recording data to perform recording on the recording medium.

14. The method according to claim 13, further comprising:
judging whether or not the recording medium is a plain paper.
